(19) United States
(12) Patent Application Publication
(10) Pub. No.: US 2007/0189113 A1
(43) Pub. Date: Aug. 16, 2007

(54) Apparatus for mixing watertreatment agent

(76) Inventor: Woo Ram Lee, Seoul (KR)

Correspondence Address: BELL, BOYD & LLOYD, LLP, P.O. Box 1135, CHICAGO, IL, 60690, US

(21) Appl. No.: 11/568,690

(22) PCT Filed: May 4, 2005
(86) PCT No.: PCT/KR05/01311

§ 371 Date: Mar. 27, 2007

(30) Foreign Application Priority Data
May 6, 2004 (KR) 20-2004-0012684

(51) Int. Cl. B01F 7/06

(52) U.S. Cl. 366/168.1

(57) ABSTRACT

Disclosed is a mixer for a water treatment agent. The mixer comprises a motor for providing a rotatory force. A vacuum port is connected to the motor, and has a drawing inlet for feeding the water treatment agent therethrough. A spraying pipe is rotatively connected to a lower part of the vacuum port so as to be in contact therewith. A propeller is rotated by a rotational shaft of the motor and thus creates vacuum strength and spraying strength. Extended parts extend from the spraying pipe so as to be positioned between blades of the propeller. The structure is simple because a vacuum generator is not used, unlike a conventional mixer. Furthermore, since vacuum strength and mixing strength do not counteract each other, thanks to the spraying pipe and the extended parts, high mixing strength is maintained, so that a mixing region, spraying strength, and a spraying rate are desirably maintained, thereby it is possible to achieve instantaneous mixing, resulting in improved treatment efficiency of the water treatment agent and a reduced cost.

### TECHNICAL FIELD

The present invention relates, in general, to a mixer for a water treatment agent and, more particularly, to a mixer for a water treatment agent, in which vacuum strength and spraying strength do not counteract each other, thus the water treatment agent is optimally drawn, sprayed, and mixe

### BACKGROUND ART

Generally, in processes of treating service water or foul water, a water treatment agent is added and then mixed with water according to necessity. For example, when using chlorine as a sterilizing agent, it is necessary to conduct rapid and uniform mixing so that the amount used and the cost are reduced and a reaction between chlorine and water to be treated is improved. In connection with this, since an aggregating agent which is an essential chemical is hydrolyzed within 0.5-1 sec, facilities and devices capable of conducting strong and rapid mixing are employed.

FIGS. 1 and 2 illustrate a conventional rapid mixer used to feed a water treatment agent into processes of treating service water or foul water. With reference to FIG. 1, when a propeller 1 is rotated by driving a motor 5, water to be treated is transported while swirling. If the rotational rate of the propeller 1 increases, spraying strength for water to be treated is generated and a sufficient vacuum is also generated at the rear of the propeller. The distance between a vacuum generator 3 and the propeller 1 is controlled, that is, the vacuum generator 3 is operated so as to move toward the upper side of the propeller 1 to increase the vacuum strength, and move away from the upper side of the propeller to reduce the vacuum strength (mixing strength is controlled in inverse proportion to the vacuum strength), thereby appropriately controlling the vacuum strength. Liquid or gas water treatment agent (chemicals) is then drawn from a water treatment agent inlet 4 through a vacuum port 2, mixed, and sprayed.

A vacuum may be maintained at a maximum of about 50-60 cmHg by a flash mixer used in the conventional watertreatment process. However, if the vacuum strength is maximized by the vacuum generator 3, the mixing strength for diluting the water treatment agent is minimized. On ther other hand, if the mixing strength is maximized, the vacuum strength is reduced. That is to say, the vacuum strength is in inverse proportion to the mixing strength. Therefore, it is impossible to simultaneously increase the vacuum strength and the mixing strength, thus the mixing has been conducted using the appropriate vacuum strength of about 20-30 cmHg and the mixing strength corresponding to that vacuum strength.

In the above-mentioned mixing, even though a high mixing strength is required in most watertreatment processes, the mixing strength is controlled to be low so as to increase the vacuum strength, in order to prevent reduced drawing of the water treatment agent due to the weak vacuum.

As well, the conventional vacuum generator 3 for generating and controlling the vacuum strength is problematic in that, since the flow of water, to be treated, which moves from the upper side of the propeller 1 to the lower side thereof while whirling, is interrupted, a spraying flow rate and a spraying flow amount are reduced, and the mixing strength, which depends on the flow amount and the flow rate, is reduced.

Additionally, in the vacuum generator 3 for generating and controlling the vacuum strength, efficiency increases as it approaches the propeller 1, but they must be spaced apart from each other by a predetermined interval of about 2-3 mm so as to minimize frictional resistance against the propeller 1. Thus, the vacuum strength is inevitably reduced.

In a spraying region affecting spraying and mixing performance according to the conventional technology, the mixing strength is reduced as the vacuum increases, thus the vacuum strength is inversely proportional to the mixing strength. In connection with this, it was confirmed in an existing domestic water purifying plant that it is impossible to assure a mixing strength effect that is higher than in a spraying region in which spraying is conducted against the stream to be treated, as shown in FIG. 2. Particularly, in the case of a metal-based aggregating agent currently used in most domestic water purifying plants, a mixing ratio of the aggregating agent and water to be treated is about 1:50,000, and the aggregating agent is used in a very small amount in a typical water purifying process. Accordingly, an operation for uniformly diffusing it in water to be treated within 1 sec is an important factor in determining whether the addition and mixing of the aggregating agent are successful. Since hydrolysis is conducted within 1 sec and adsorption of colloidal particles occurs simultaneously, the diffusion of the aggregating agent must be achieved within 1 sec so as to assure various effects, such as reduced usage of aggregating agent, improvement of aggregation and precipitation efficiency, reduced cost of water purification, and reduced generation of sludge. However, the above-mentioned conventional device is problematic in that, since the aggregating agent comes into contact with water to be treated after hydration thereof is finished, the effects are reduced.

### DISCLOUSRE OF INVENTOIN

Technical Problem

Accordingly, the present invention has been made keeping in mind the above problems occurring in the prior art, and an object of the present invention is to provide a mixer for a water treatment agent employing the dynamic law in which a force is in proportion to a mass, in which the flow rate of water sprayed in conjunction with the water treatment agent is increased, thus the mass is increased, thereby improving the mixing strength and mixing rate. Hence, spraying strength is increased to enlarge a mixing region, thereby it is possible to conduct instantaneous mixing of the water treatment agent.

Another object of the present invention is to provide a mixer for a water treatment agent, in which the vacuum strength required to draw the water treatment agent is prevented from varying in inverse proportion to the mixing strength required to spray and mix the water treatment agent and water to be treated, so that the vacuum strength and the mixing strength are simultaneously maximized.

A further object of the present invention is to provide a mixer for a water treatment agent, in which a vacuum is generated without a vacuum generator so as to prevent vacuum strength loss and interruption of a water stream due to the vacuum generator.

Technical Solution

In order to accomplish the above objects, the present invention provides a mixer for a water treatment agent, in which the water treatment agent is mixed with water to be treated. The mixer comprises a motor for providing a rotatory force; a vacuum port which is connected to the motor and which has a drawing inlet for feeding the water treatment agent therethrough; a spraying pipe which is rotatively connected to a lower part of the vacuum port so as to be in contact therewith; a propeller which is rotated by a rotational shaft of the motor and thus creates vacuum strength and spraying strength; and extended parts which extend from the spraying pipe so as to be positioned between blades of the propeller.

Furthermore, in the mixer for the water treatment agent according to the present invention, it is preferable that the extended parts be at an angle of 0°-90°, and preferably 10°-80°, with respect to the spraying pipe.

Preferably, in the mixer for the water treatment agent according to the present invention, contact surfaces between a lower part of the vacuum port and an upper part of the spraying pipe are treated with any one of ceramic and Teflon, and the propeller, the rotational shaft, the spraying pipe, the extended parts, and the vacuum port are made of titanium or a titanium alloy having high strength and super corrosion resistance.

Advantageous Effects

The present invention is advantageous in that, since vacuum strength and mixing strength do not counteract each other because of a spraying pipe and an extended part, high mixing strength is maintained, so that a mixing region, spraying strength, and a spraying rate are desirably maintained, thereby it is possible to achieve instantaneous mixing, resulting in improved treatment efficiency of the water treatment agent and reduced cost.

The present invention is advantageous in that, since vacuum strength required to draw the water treatment agent is prevented from varying in inverse proportion to mixing strength required to spray and mix the water treatment agent and water to be treated, the vacuum strength and the mixing strength are simultaneously maximized.

Furthermore, the present invention is advantageous in that, since a vacuum generator is not used, unlike a conventional mixer, the structure is simple, and vacuum strength loss and interruption of a water stream due to the vacuum generator are prevented.

### BRIEF DESCRIPTION OF THE DRAWINGS

FIG. 1 is a front view of a conventional mixer for a water treatment agent;

FIG. 2 illustrates use of the mixer for the water treatment agent of FIG. 1;

FIG. 3 is a front view of a mixer for a water treatment agent according to the present invention;

FIG. 4 is a sectional view of the mixer for the water treatment agent of FIG. 3;

FIG. 5 is a perspective view of a main part of the mixer for the water treatment a gent according to the present invention;

FIG. 6 is a bottom view of the mixer for the water treatment agent according to the present invention; and

FIG. 7 illustrates the use of the mixer for the water treatment agent according to the present invention.

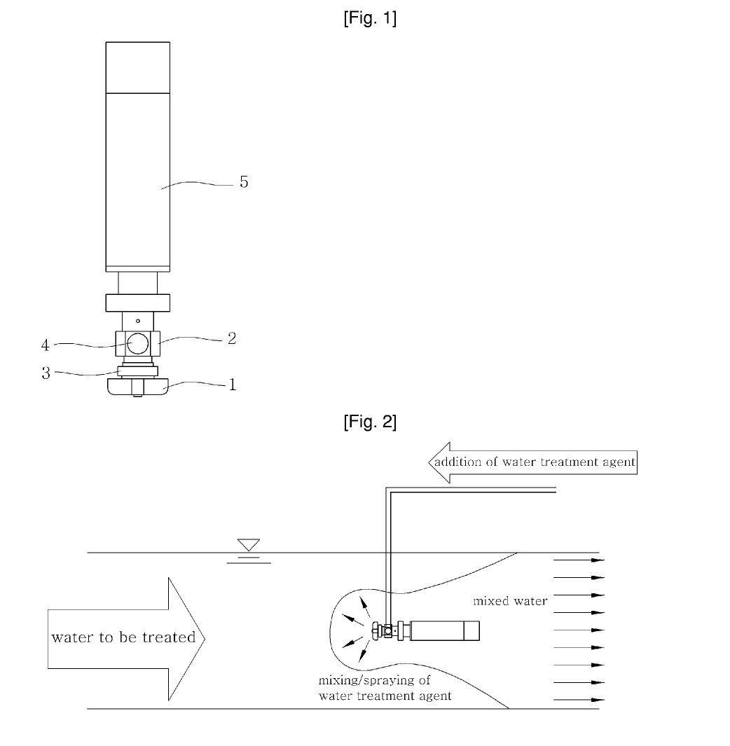

### DESCRIPTION OF REFERENCE NUMERALS FOR MAIN PARTS OF THE DRAWINGS

6: propeller
7: spraying pipe
7a: extended part
8: vacuum port
9: water treatment agent inlet
10: motor
11: seal
12: rotational shaft
13: internal shaft of propeller
14: bolt
15: prominence and depression

### BEST MODE FOR CARRYING OUT THE INVENTION

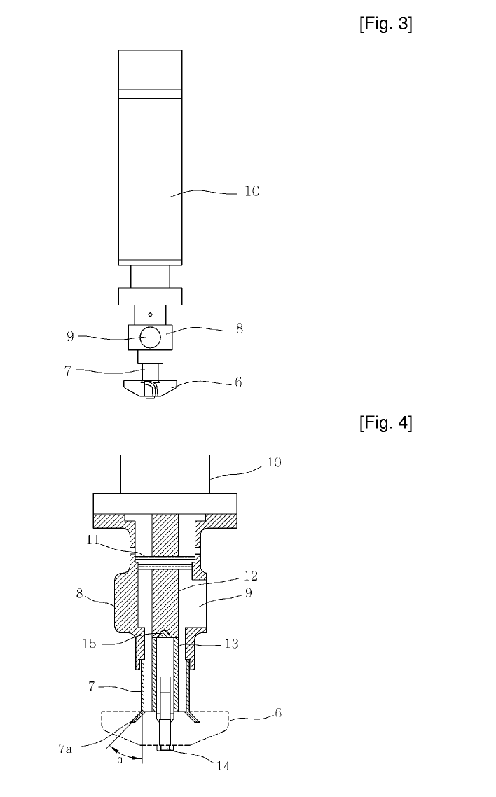

With reference to FIGS. 3 and 4, a mixer for a water treatment agent according to the present invention comprises a motor 10 at an upper part thereof for supplying a rotatory force.

A vacuum port 8 is provided on the bottom of a main body of the motor 10. A water treatment agent inlet 9 is formed in the vacuum port 8 to draw the water treatment agent therethrough. A typical seal 11 which does not require a supporting force is provided on an internal wall of the vacuum port so as to be fitted around a rotational shaft 12, thereby preventing the vacuum strength from being reduced and enabling a water treatment agent stream to nicely flow when the water treatment agent is drawn through the water treatment agent inlet 9.

A spraying pipe 7 is rotatively connected to a lower side of the vacuum port 8, in detail, an upper side of the spraying pipe 7 is rotatively in contact with the vacuum port in a sliding contact manner or a rolling contact manner. It is preferable in terms of structure that a contact surface between the lower side of the vacuum port 8 and the upper side of the spraying pipe 7 be coated with ceramic at a portion thereof and with Teflon at the other portion thereof so as to increase durability, and, needless to say, conventional various treatment methods may be used. Furthermore, the coating is conducted in order to reduce frictional force occurring between the fixed vacuum port 8 and the spraying pipe 7, which rotates at a high rate, and also to maintain desired watertightness so as to prevent the vacuum strength from being reduced.

A propeller 6 is provided at a lower part of the spraying pipe 7, and rotates while an internal shaft 13 of the propeller 6 is connected to the rotational shaft 12 of the motor 10. In connection with this, the rotational shaft 12 and the internal shaft 13 of the propeller may be connected to each other through various known methods, and, in the present embodiment, they are connected to each other using a bolt 14 provided through the center part of the propeller 6. It is preferable to bring the rotational shaft 12 into contact with the internal shaft 13 of the propeller so that a prominence 15 of the internal shaft 13 engages with a depression 15 of the rotational shaft 12, thereby the bolt 14 is prevented from loosening and the frictional force is increased. The spraying pipe 7 receives a rotatory force from the motor 10 through the propeller 6 and extended parts 7a and thus rotates.

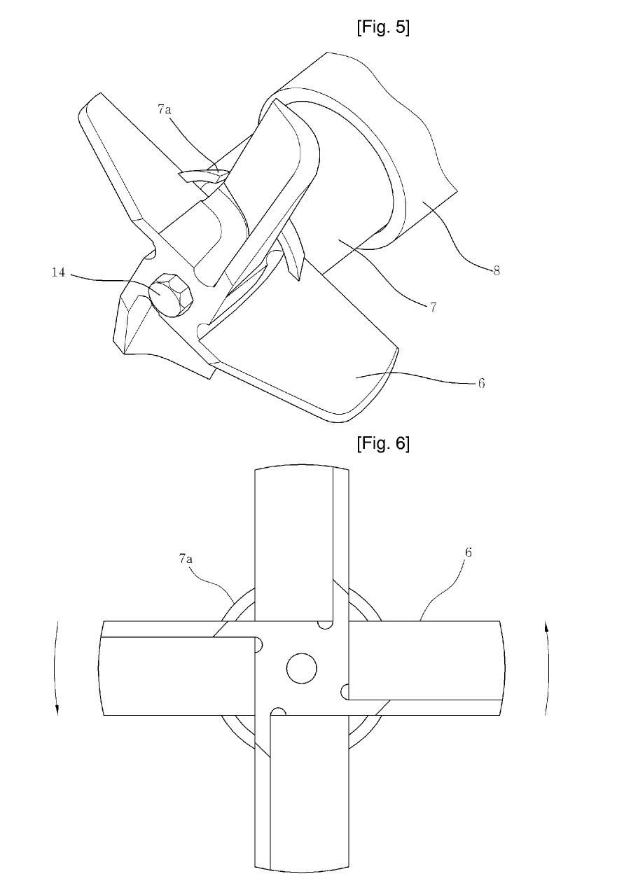

With reference to FIGS. 5 and 6, in the mixer of the present invention, the extended parts 7a extend from the lower part of the spraying pipe 7 so as to be positioned between blades of the propeller 6. The extended parts 7a induce a diffusion angle and a diffusion range of mixed water sprayed due to rapid rotation of the propeller 6, and prevent sprayed mixed water from flowing toward the center of the propeller, at which a vaccum is to be created, so as to spray a great amount of mixed water while the high vacuum is maintained. The extended parts 7a are separated from each other by the blades of the propeller 6, and form a funnel in conjunction with the spraying pipe. As shown in FIG. 4, the extended parts 7a may be at a predetermined angle (α) of 0°-90° to the spraying pipe, and the spraying strength and the vacuum strength depend on the angle. The maximum spraying strength and the maximum vacuum strength can be gained at the angle of, preferably 10°-80°, and more preferably 40°-70°. However, since they depend on lengths of the extended parts 7a, the contact area between the propeller 6 and water to be treated during the rotation of the propeller 6, the rotation rate of the propeller 6, and the diameter of the spraying pipe 7, the angle may be selected according to the circumstances. Water to be treated and the water treatment agent are mixed and sprayed using the spraying strength and the vacuum strength depending on the characteristics of the extended parts 7a.

A description will be given of operation of the above-mentioned mixer for the water treatment agent according to the present invention.

When the motor 10 is driven, the propeller 6 rotates at a high rate, because the internal shaft 13 of the propeller is connected to the rotational shaft 12, and thus sprays water to be treated. Furthermore, the water treatment agent is drawn through the vacuum port 8 and the spraying pipe 7 due to the vacuum strength created at the rear part of the propeller, and is then mixed with water.

Since the mixer of the present invention does not require a vacuum generator 3 which is used in a conventional mixer, water to be treated is sprayed without interruption. Furthermore, the contact area between water to be treated and the propeller 6 increases, and the amount of water sprayed increases by the increased contact area, thereby the mass of water sprayed increases. Since velocity and force are in proportion to mass, the spraying rate and the spraying strength of water to be treated increase in proportion to the mass of water to be treated. The increased spraying rate and spraying strength are essential to conduct rapid and instantaneous mixing, and cause an enlarged mixing region, thereby improving contact efficiency between the water treatment agent and water to be treated.

In the above-mentioned mixer of the present invention, since an inflow of water to be treated is interrupted by the spraying pipe 7 and the extended parts 7a, the vacuum strength generated by the propeller 6 is transported without being weakened to the vacuum port 8 to draw the water treatment agent. The extended parts 7a do not interrupt the flow of water to be sprayed by the propeller 6, and block the flow of water into the propeller 6 in which the vacuum is to be created, thus assuring space for creation of the vacuum. Thereby, optimal vacuum strength is assured, resulting in maximized spraying and mixing strengths.

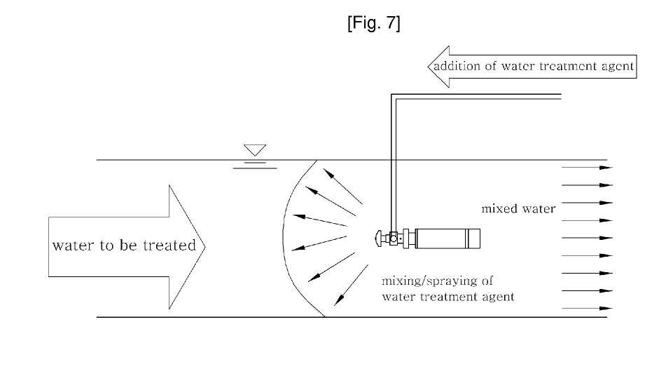

Referring to FIG. 7, the mixing region is enlarged in comparison with FIG. 2 because the mixing strength is increased, and the degree of mixing increases in proportion to the mixing strength. The mixing strength is in proportion to the mass of water sprayed by the propeller 6, and the increased mass of water to be treated is caused only by the increased contact area between the propeller 6 and water to be treated, because the vacuum generator 3 is not employed.

The mixer of the present invention may be located at various positiones. It may be partially immersed in water to be treated, or alternatively, totally immersed in a mixing bath.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

Recently, many studies have been made to suggest countermeasures for shortage of water resources. With respect to this, the present inveniton provides a simple structure in comparison with a conventional mixer for a water treatment agent so as to reduce a production cost, assures excellent mixing performance, and may be used for general applications.

1. A mixer for a water treatment agent, in which the water treatment agent is mixed with water to be treated, comprising:
a motor for providing a rotatory force;
a vacuum port which is connected to the motor and comprising a drawing inlet for feeding the water treatment agent therethrough;
a spraying pipe which is rotatively connected to a lower part of the vacuum port so as to be in contact therewith;
a propeller which can be rotated by a rotational shaft of the motor and thus creates a vacuum strength and a spraying strength; and
extended parts which extend from the spraying pipe so as to be positioned between blades of the propeller.

2. The mixer as set forth in claim 1, wherein the extended parts are at an angle of 0°-90° with respect to the spraying pipe.

3. The mixer as set forth in claim 1, wherein contact surfaces between a lower part of the vacuum port and an upper part of the spraying pipe are treated with a material selected from the group consisting of ceramic and Teflon.

4. The mixer as set forth in claim 1, wherein the propeller, the rotational shaft, the spraying pipe, the extended parts, and the vacuum port are made of titanium or a titanium alloy having a high strength and a super corrosion resistance.

5. A mixer comprising:
a motor;
a vacuum port comprising a drawing inlet for feeding a water treatment agent therethrough;
a spraying pipe connected to a lower part of the vacuum port;
a propeller connected to a shaft of the motor; and
parts extending from the spraying pipe that are located between blades of the propeller.
